(19) United States
(12) Patent Application Publication
(10) Pub. No.: US 2021/0379917 A1
(43) Pub. Date: Dec. 9, 2021

(54) DROP-ON-DEMAND MULTI-PASS PRINTING ON PLASTIC CARDS

(71) Applicant: Entrust Corporation, Shakopee, MN (US)

(72) Inventors: Brett McDonough, Shakopee, MN (US); Kevin Bontrager, Shakopee, MN (US); Brendan Hinnenkamp, Shakopee, MN (US); Cory Wooldridge, Shakopee, MN (US); Daniel Sarkinen, Shakopee, MN (US); Jon Wawra, Shakopee, MN (US)

(21) Appl. No.: 17/340,744

(22) Filed: Jun. 7, 2021

Related U.S. Application Data
(60) Provisional application No. 63/036,037, filed on Jun. 8, 2020.

(51) Int. Cl. B41M 5/00; B41M 7/00

(52) U.S. Cl. CPC B41M 5/0047; B41M 2205/40; B41M 7/0045; B41M 5/0064

(57) ABSTRACT

A multi-pass drop-on-demand (DOD) card printing mechanism that performs multi-pass DOD printing on a surface of a plastic card whereby the plastic card is transported past one or more DOD print heads multiple times for DOD printing on the card surface with each pass past the DOD print head(s). In a first printing pass, at least one material is applied to a surface of the plastic card using at least one DOD print head. In a second printing pass that occurs after the first printing pass, at least one additional material is applied to the surface of the plastic card in the card processing system using at least one DOD print head.

### FIELD

This technical disclosure relates to card processing systems that personalize or otherwise process plastic cards such as financial cards including credit and debit cards, identification cards, driver's licenses, gift cards, and other plastic cards.

### BACKGROUND

Plastic cards such as financial cards including credit and debit cards, identification cards, driver's licenses, gift cards, and other plastic cards may be personalized with personal information of the intended card holder. Examples of personalization include, but not are limited to, names, addresses, photographs, account numbers, employee numbers, or the like. The personal information may be applied to the card in a number of different ways including, but not limited to, printing on a surface of the document, storing the information on a magnetic stripe disposed on the card, and storing the information on an integrated circuit chip or smart chip embedded in the card.

Card processing systems that personalize plastic cards are utilized by institutions that issue such personalized plastic cards. In some cases, card processing systems can be designed for relatively small scale, individual card personalization in relatively small volumes, for example measured in tens or low hundreds per hour. In these mechanisms, a single document to be personalized is input into a card processing system, which typically includes one or two processing capabilities, such as printing and laminating. These processing machines are often termed desktop processing machines because they have a relatively small footprint intended to permit the processing machine to reside on a desktop. Many examples of desktop processing machines are known, such as the SD or CD family of desktop card printers available from Entrust Datacard Corporation of Shakopee, Minn. Other examples of desktop processing machines are disclosed in U.S. Pat. Nos. 7,434,728 and 7,398,972, each of which is incorporated herein by reference in its entirety.

For large volume batch production of personalized cards (for example, on the order of high hundreds or thousands per hour), institutions often utilize card processing systems that employ multiple processing stations or modules to process multiple cards at the same time to reduce the overall per card processing time. Examples of such machines include the MX and MPR family of central issuance processing machines available from Entrust Datacard Corporation of Shakopee, Minn. Other examples of central issuance processing machines are disclosed in U.S. Pat. Nos. 4,825,054, 5,266,781, 6,783,067, and 6,902,107, all of which are incorporated herein by reference in their entirety

### SUMMARY

Card processing mechanisms, systems and methods are described where multi-pass drop-on-demand (DOD) printing is performed on a surface of a plastic card whereby the plastic card is transported past one or more DOD print heads multiple times (i.e. at least two times) for DOD printing on the card surface with each pass past the DOD print head(s). The DOD printing in each printing pass can be the application of one or more inks to the card surface and/or the application of a varnish to the card surface.

In the multi-pass DOD printing described herein, in a first printing pass at least one material is applied to a surface of the plastic card using at least one DOD print head of a DOD card printing mechanism. In a second printing pass that occurs after the first printing pass, at least one additional material is applied to the surface of the plastic card in the card processing system using at least one DOD print head of the DOD card printing mechanism.

In some embodiments, the at least one additional material can be applied so that it is at least partially over or at least partially covers the at least one material. This permits creation of multi-layer features on the card surface including, but not limited to, layered printing, texture features, security features, and the like.

In some embodiments, the material(s) applied to the surface can be curable via radiation applied to the material, for example ultra-violet (UV) radiation. After the first printing pass, the plastic card can be directed to a UV curing station to partially or fully cure the material applied to the surface. The curing (whether partial or full) after the first printing pass should be sufficient to stabilize the position of the applied radiation curable material to prevent the material from flowing or shifting position as the card is being transported for the second or subsequent printing pass, and prevent contamination of transport mechanisms and other equipment by the applied radiation curable material. After final application of radiation curable material to the card surface, full curing of the radiation curable material can take place.

In one embodiment described herein, a method of drop-on-demand printing on a plastic card in a card processing system that includes a drop-on-demand card printing mechanism that is configured to perform drop-on-demand printing is described. The card has a first surface and a second surface. The method includes in a first printing pass, applying at least one material to the first surface of the plastic card in the card processing system using at least one drop-on-demand print head of the drop-on-demand card printing mechanism, and in a second printing pass that occurs after the first printing pass, applying at least one additional material to the first surface of the plastic card in the card processing system using at least one drop-on-demand print head of the drop-on-demand card printing mechanism. The at least one additional material may be applied at least partially over the at least one material. In other embodiments, the at least one additional material does not overlap the at least one material.

In another embodiment described herein, a card processing system can include a drop-on-demand card printing mechanism disposed along a card processing path. The drop-on-demand card printing mechanism can include a plurality of drop-on-demand print heads each of which prints a different radiation curable material, a first electromagnetic radiation source for curing radiation curable material applied to plastic cards by the drop-on-demand print heads, and a second electromagnetic radiation source for curing radiation curable material applied to plastic cards by the drop-on-demand print heads, where the first electromagnetic radiation source is downstream from the drop-on-demand print heads. A mechanical card transport is provided that transports a plastic card from a location downstream from the drop-on-demand print heads to a location upstream of the drop-on-demand print heads.

### DRAWINGS

FIG. 1 illustrates an example of a method of DOD printing on a plastic card described herein.

FIG. 2 illustrates an example of one surface of a plastic card.

FIG. 3 is a cross-sectional view taken along line 3-3 of FIG. 2 showing an example of one printed feature resulting from the method described herein.

FIG. 4 is an example of a DOD card printing mechanism that can implement the methods described herein.

FIG. 5 is another example of a DOD card printing mechanism that can implement the methods described herein.

FIG. 6 is another example of a DOD card printing mechanism that can implement the methods described herein.

FIG. 7 schematically illustrates an embodiment of a card processing system that can utilize the DOD card printing mechanisms described herein.

### DETAILED DESCRIPTION

The following is a description of multi-pass DOD printing that is performed on a surface of a plastic card whereby the plastic card is transported past one or more DOD print heads multiple times (i.e. at least two times) for DOD printing on the card surface with each pass past the DOD print head(s). The DOD printing in each printing pass can be the application of one or more inks to the card surface and/or the application of a varnish to the card surface and/or the application of any other material that can be applied by DOD print heads. The term “printing pass” or the like as used herein and in the claims does not require complete transport of the entire card past the print head(s). Instead, a “printing pass” includes transport of just the portion of the card being printed on past one or more print heads in a first movement direction of the card. However, a printing pass may include transport of the entire card past the print heads.

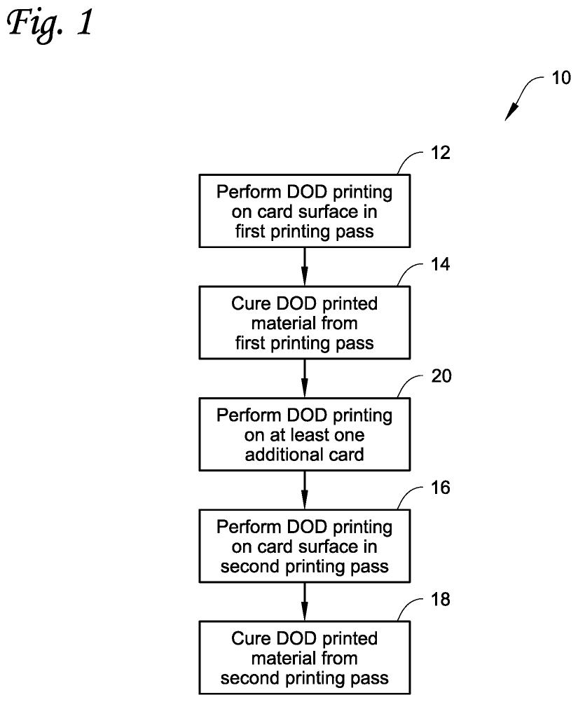

For example, with reference to FIG. 1, a method 10 described herein includes in a first step 12 performing DOD printing on a surface of a plastic card in a first printing pass in a DOD card printing mechanism. The DOD printing in the first printing pass can be the application of any material(s) that can be applied using one or more DOD print heads. In some embodiments, the material is radiation curable, for example using UV radiation. Assuming the material applied in the first printing pass is radiation curable, the applied material can be partially or fully cured in step 14, for example by transporting the plastic card to a radiation curing station. If the applied material does not require radiation curing, the step 14 is not required. Thereafter, the plastic card is transported back to the DOD print head(s) to apply material to the same surface of the card in a second printing pass at step 16. If the material applied in the second printing pass is radiation curable, the material applied in the second printing step can be partially or fully cured in step 18, for example by transporting the plastic card to a radiation curing station which can be the same or different radiation curing station used after the first printing pass. Third, fourth, etc. printing passes can also be implemented in some embodiments.

In some embodiments, one or more additional plastic cards can be printed on by the DOD print head(s) in step 20 that takes place between step 12 and step 16. The additional card(s) can be on its first or second printing pass past the DOD print head(s).

The plastic cards herein include, but are not limited to, financial cards including credit and debit cards, identification cards, driver's licenses, gift cards, and other plastic cards. The plastic cards may be personalized with personal information of the intended card holder. Examples of personalization include, but not are limited to, names, addresses, photographs, account numbers, employee numbers, or the like. The personal information may be applied to the card in a number of different ways including, but not limited to, printing on a surface of the document, storing the information on a magnetic stripe disposed on the card, and storing the information on an integrated circuit chip or smart chip embedded in the card.

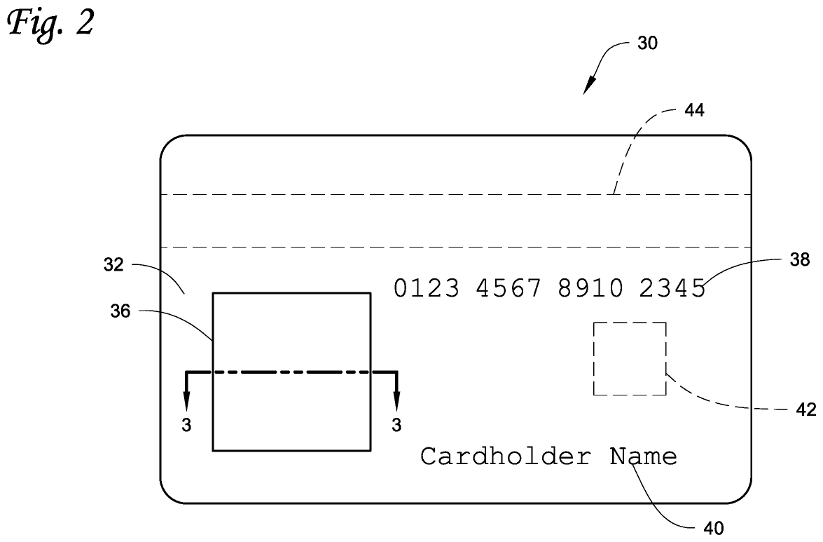

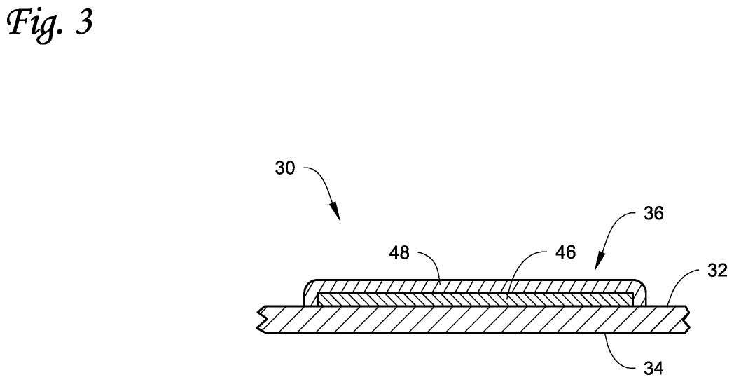

Referring to FIGS. 2 and 3, an example of a plastic card 30 is illustrated. The card 30 includes a first surface 32 (which may be a top surface or a bottom surface) and a second surface 34 (which may be the top surface or the bottom surface) opposite the first surface 32. In the illustrated example, the card 30 includes personalization on the first surface 32, including a printed portrait photograph 36 of the intended card holder, an account number 38 assigned to the card holder, and the name 40 of the card holder. The account number 38 and/or the name 40 can be printed or embossed. The card 30 can also include a contactless or contact integrated circuit chip 42 and/or a magnetic stripe 44 on the second surface 34.

The first and second printing passes can be used to print any printed feature on the first surface 32 and on the second surface 34, including the photograph 36, the account number 38 and/or the name 40. In some embodiments, the material applied in the second printing pass at least partially or completely overlaps the material applied in the first printing pass. In some embodiments, the material applied in the second printing pass does not overlap the material applied in the first printing pass.

Many combinations and layers of materials applied in the first and second printing passes are possible. Examples of combinations of materials or layers include, but are not limited to, applying ink in the first printing pass and applying a varnish and/or a durability layer in the second printing pass; printing a layer of white on a black substrate in the first printing pass and then printing colored ink on top of the white layer in the second printing pass; printing a first layer of ink in the first printing pass and printing a second layer of the ink on top of the first layer to achieve a color density not achievable in a single pass; printing multiple layers to achieve a textured effect on the card surface; printing multiple layers to create security features on the card surface; and many others. In some embodiments, the account number or a logo on the card can be printed from multiple layers and raised above the surrounding card surface. In some embodiments, “embossed” characters can be created from multiple printing passes described herein to replace or supplement traditional embossing formed on plastic card. In such multi-layer characters, the characters would be raised from the surrounding card surface like traditional embossed characters, however the multi-layer characters would not be indented from the opposite surface of the card like traditional embossed characters.

To help explain the concepts described herein, the printed feature will be described as being the photograph 36. Referring to FIG. 3, the photograph 36 includes a layer 46 of ink applied by one or more DOD print heads in the first printing pass, and a clear or translucent varnish layer 48 applied by one or more DOD print heads in the second printing pass. The thicknesses of the layers 46, 48 are greatly exaggerated to illustrated to better illustrate the concepts. The ink of the layer 46 can be monochromatic (e.g. a single color such as black) or multi-color (e.g. CMYK) and forms the image of the face of the cardholder. The ink forming the layer 46 may be radiation curable ink. The layer 48 can be a material that is applied at least partially over the layer 46 to protect the layer 46 of ink and extend its use life. The material forming the layer 48 may also be radiation curable. FIG. 3 illustrates the layer 48 as being applied in the second printing pass to completely cover the layer 46 including the top and the sides of the layer 46. However, the layer 48 may only cover the top of the layer 46.

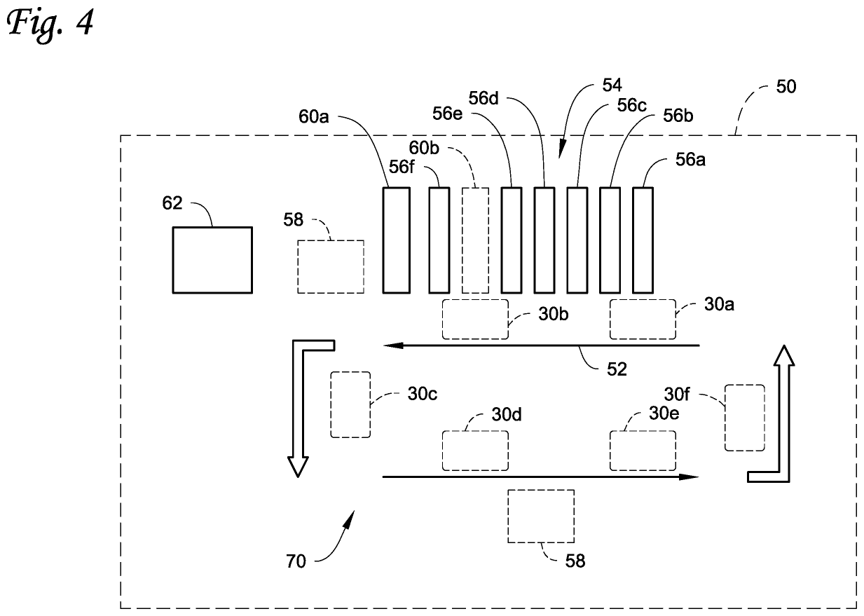

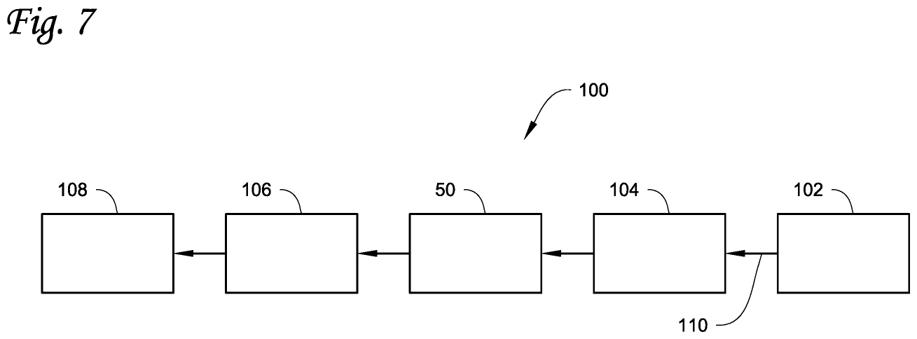

FIG. 4 illustrates an example of a DOD card printing mechanism 50 that can implement the DOD printing with multiple printing passes described herein. The mechanism 50 can be a stand-alone mechanism that operates by itself to perform the DOD plastic card printing described herein. The mechanism 50 may also be part of a larger system and used with other card processing mechanisms to process plastic cards as described further below with respect to FIG. 7. The mechanism 50 can print cards at a card rate of up to about 6000 cards per hour or more.

In the example in FIG. 4, the mechanism 50 has a primary card travel path 52 and at least one print station 54 on the primary card travel path 52 that performs DOD printing. The print station 54 includes at least one DOD print head, in this example six DOD print heads including a DOD print head 56a for Cyan ink, a DOD print head 56b for Magenta ink, a DOD print head 56c for Yellow ink, a DOD print head 56d for Black ink, a DOD print head 56e for White ink, and an optional DOD print head 56f for applying a varnish.

The mechanism 50 can further include at least one card flipper 58 for flipping cards 180 degrees which is useful for printing on both surfaces 32, 34 of the card 30. The flipper 58 can be located anywhere in the mechanism 50 that is suitable for performing its flipping function. In the illustrated example, the flipper 58 is shown as being located downstream of the print station 54. In other embodiments, the flipper 58 can located on or be incorporated as part of a card recirculation path (described further below), or located upstream of the print station 54.

The mechanism 50 can further include one or more UV curing stations. For example, there can be a UV curing station 60a located immediately downstream of the DOD print heads. In one embodiment, the UV curing station 60a can be configured to partially cure the material applied to the card surface by the DOD print head(s) in the first printing pass. In embodiments when the DOD print head 56f is present and applies a varnish, another UV curing station 60b can be provided between the DOD print head 56f and the last DOD print head applying color ink, in this example the print head 56e. The UV curing station 60b can be configured to partially cure the ink prior to the varnish being applied by the DOD print head 56f over the ink. There can also be a UV curing station 62 near an exit of the mechanism 50. The UV curing station 62 can be configured and used to perform a final or complete cure of radiation curable material applied to the card.

To achieve the first and second (or more) printing passes, a mechanism is provided to transport the card past the print station 54 at least twice. A suitable mechanical card transport transports the card past the DOD print head(s) of the print station 54 in the first printing pass, and then transports the card past the drop-on-demand print heads a second time to perform the second printing pass. Any mechanical card transport that can transport the card past the DOD print heads at least twice can be used.

For example, FIG. 4 illustrates a card recirculation mechanism that uses a return card travel path 70 that recirculates the card from a location downstream of the DOD print heads to a location on the primary card travel path 52 that is upstream of the DOD print heads. Further details of a card recirculation mechanism with a return card travel path are disclosed in U.S. Pat. No. 10,049,320 the entire contents of which are incorporated herein by reference. The card recirculation mechanism in FIG. 4 permits the mechanism 50 to simultaneously handle and process multiple cards at the same time. For example, FIG. 4 illustrates two cards 30a, 30b simultaneously in the print station 54 (for example in a first printing pass or on a second printing pass), and four cards 30c, 30d, 30e, 30f at various locations on the return card travel path 70 being returned upstream of the print station 54 for a second or additional printing pass.

Another example of a card recirculation mechanism that can be used in FIG. 4 is the type of mechanism, referred to as a dual card transport, disclosed in U.S. Pat. No. 10,507,677 the entire contents of which are incorporated herein by reference. In the dual card transport disclosed in U.S. Pat. No. 10,507,677, first and second card transports can be actuated between a common card pick-up location and a common card discharge location, and in between one of the card transports can transport a card to and through a card processing mechanism, such as a printer, while the other card transport can by-pass the card processing mechanism as the other card transport returns to the card pick-up location. The dual-card transport mechanism also permits the mechanism 50 to simultaneously handle and process multiple cards, in this case two cards, at the same time.

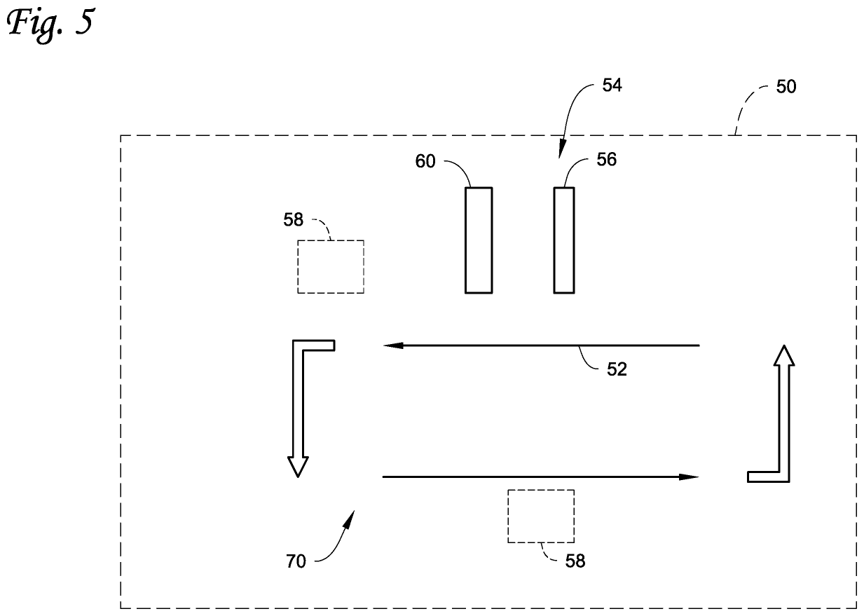

FIG. 5 illustrates another example of the DOD card printing mechanism 50 that can implement the DOD printing with multiple printing passes described herein. The mechanism 50 can be a stand-alone mechanism that operates by itself to perform the DOD plastic card printing described herein. The mechanism 50 may also be part of a larger system and used with other card processing mechanisms to process plastic cards as described further below with respect to FIG. 7. In the mechanism 50 in FIG. 5, elements that are similar or identical in function to elements in the mechanism 50 in FIG. 4 are referenced using the same reference numerals.

In the example in FIG. 5, the mechanism 50 has the primary card travel path 52 and the at least one print station 54 on the primary card travel path 52 that performs DOD printing. However, unlike in FIG. 4, the print station 54 in FIG. 5 include a single DOD print head 56. The DOD print head 56 can print any color ink such as cyan, magenta, yellow, black, or white, or a non-ink such as a varnish. The mechanism 50 further includes a card flipper 58, a UV curing station 60, and a mechanism is provided to transport the card past the print station 54 at least twice. In this example, since only the single UV curing station 60 is shown, the UV curing station 60 performs the functions of both the UV curing stations 60, 62 in FIG. 4. The transport mechanism can be a card recirculation mechanism such as one that uses a return card travel path 70 that recirculates the card from a location downstream of the DOD print heads to a location on the primary card travel path 52 that is upstream of the DOD print heads as described above for FIG. 4, such as disclosed in U.S. Pat. No. 10,049,320 the entire contents of which are incorporated herein by reference. Alternatively, the card recirculating mechanism can be a dual card transport mechanism as described above for FIG. 4, like the type disclosed in U.S. Pat. No. 10,507,677 the entire contents of which are incorporated herein by reference.

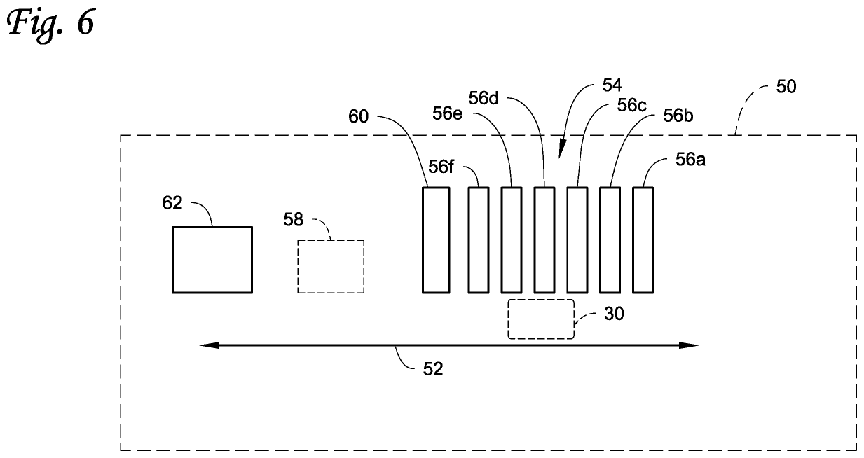

FIG. 6 illustrates another example of the DOD card printing mechanism 50 that can implement the DOD printing with multiple printing passes described herein. The mechanism 50 can be a stand-alone mechanism that operates by itself to perform the DOD plastic card printing described herein. The mechanism 50 may also be part of a larger system and used with other card processing mechanisms to process plastic cards as described further below with respect to FIG. 7. In the mechanism 50 in FIG. 5, elements that are similar or identical in function to elements in the mechanism 50 in FIGS. 4 and 5 are referenced using the same reference numerals.

In the example in FIG. 6, the mechanism 50 has the primary card travel path 52 and the at least one print station 54 on the primary card travel path 52 that performs DOD printing. The print station 54 includes at least one DOD print head, in this example six DOD print heads including the DOD print head 56a for Cyan ink, the DOD print head 56b for Magenta ink, the DOD print head 56c for Yellow ink, the DOD print head 56d for Black ink, the DOD print head 56e for White ink, and the optional DOD print head 56f for applying a varnish.

The mechanism 50 in FIG. 6 further includes the card flipper 58, the UV curing station 60, the UV curing station 62 and a mechanism is provided to transport the card past the print station 54 at least twice. In this example, the transport mechanism can be a reversible card transport mechanism whereby the card 30 is transported past the DOD print heads 56a-f in a first printing pass, and then the card can be reversed in direction to transport the card back toward a location upstream of the print heads 56a-f. The construction and operation of reversible card transport mechanisms for transporting a card are well known in the art. The second printing pass can occur as the card 30 is being transported in reverse (i.e. in the direction toward the location upstream of the print heads 56a-f) whereby during the first and second printing passes the card 30 moves in opposite directions during each printing pass. Alternatively, the card 30 can be transported partially or fully upstream of the DOD print head 56a-f and then transported in a downstream direction during the second printing pass whereby during the first and second printing passes the card 30 moves in the same directions during each printing pass. Because of the reversing of the card 30 by the reversible card transport mechanism, the mechanism 50 in FIG. 6 typically handles only a single card at any moment in time.

As indicated above, the mechanisms 50 in FIGS. 4-6 can be used as stand-alone mechanisms or they can be part of a larger system and used with other card processing mechanisms to process plastic cards. FIG. 7 schematically depicts use of any one of the mechanisms 50 in FIGS. 4-6 in a larger system 100 with other card processing mechanisms. The system 100 can include a card feed mechanism 102, a card processing mechanism 104, the DOD card printing mechanism 50, another card processing mechanism 106, and a card output 108 into which processed cards are output. The card processing system 100 illustrated in FIG. 7 is a large volume, batch production or central issuance card processing system. However, the DOD card printing mechanisms 50 described herein can be used in other card processing systems including in lower volume, desktop card processing systems.

The mechanisms 50, 104, 106 can be arranged in any order in the system 100. In addition, not all of the mechanisms 50, 104, 106 need to be utilized. For example, in one embodiment, the DOD card printing mechanism 50 can be used by itself without the other mechanisms 104, 106. In addition, additional card processing mechanisms can be utilized with the mechanisms 50, 104, 106.

The card feed mechanism 102 feeds cards to be processed by the system 100 onto a card processing path 110. The card feed mechanism 102 can include one or more card hoppers containing cards waiting to be fed one-by-one onto the card processing path 110.

The card processing mechanism 104 is disposed on and along the card processing path 22 downstream of the card feed mechanism 102. The card processing mechanism 104 is configured to perform one or more processing operations on each card. The card processing mechanism 104 can be a smart card programming mechanism that is configured to, for example, program a chip embedded in each card. The smart card programming mechanism can be configured to program one card at a time. Alternatively, the smart card programming mechanism can be configured to simultaneously program multiple cards. Example of a smart card programming mechanisms that simultaneously program multiple cards that could be utilized are described in U.S. Pat. No. 6,695,205 (disclosing an elevator-type smart card programming mechanism) and U.S. Pat. No. 5,943,238 (disclosing a barrel-type smart card programming mechanism), the entire contents of each patent are incorporated herein by reference. The card processing mechanism 104 may alternatively be configured to program a magnetic stripe on each card, or the card processing mechanism 104 can perform both smart card programming and magnetic stripe programming. In another embodiment, a separate magnetic stripe programming mechanism (not illustrated) can be located between the card processing mechanism 104 and the card feed mechanism 102 or between the card processing mechanism 104 and the DOD card printing mechanism 50. In addition, the card processing mechanism 104 can be located at other positions in the system 100 or is not used, in which case the card processing mechanism 104 is not between the DOD card printing mechanism 50 and the card feed mechanism 102. The card processing mechanism 104, for example when configured as a smart card programming mechanism, can also be located downstream of the DOD card printing mechanism 50.

In the embodiment illustrated in FIG. 7, the DOD card printing mechanism 50 is shown as being downstream of the card processing mechanism 104. In another embodiment, the DOD card printing mechanism 50 can be the first processing mechanism downstream from the card feed mechanism 102.

The embodiment illustrated in FIG. 7 also shows the card processing mechanism 106 as being disposed along the card processing path 22 downstream of the DOD card printing mechanism 50. However, other locations of the card processing mechanism 106 in the system 100 are possible. The card processing mechanism 106 is configured to perform a processing operation on each card that is different than the card processing operations performed by the card processing mechanism 104. For example, the card processing mechanism 106 can be configured to perform laser marking on each card using a laser, and/or apply a hologram overlay onto each card, and/or perform other card processing operations.

Cards that have been processed are collected in the card output 108 that is disposed along the card processing path 22 downstream of the DOD card printing mechanism 50. The processed cards can then be distributed to their intended recipients, for example by attaching the cards to mailer forms and mailing to the intended recipients.

Many other card processing mechanisms can be used in addition to, or in place of, the processing mechanisms illustrated in FIG. 7. For example, an indent mechanism that performs indenting on each card can be provided upstream of or downstream of the DOD card printing mechanism 50. A quality assurance mechanism that checks the quality of the processed cards can be located between the card output 108 and the card processing mechanism 106. Many other processing mechanisms, and combinations of processing mechanisms, can be utilized.

The cards can be transported through the DOD card printing mechanism 50 and throughout the entire system 100 by one or more suitable mechanical card transport mechanisms (not shown). Mechanical card transport mechanism(s) for transporting cards in card processing systems of the type described herein are well known in the art. Examples of mechanical card transport mechanisms that could be used are known in the art and include, but are not limited to, transport rollers, transport belts (with tabs and/or without tabs), vacuum transport mechanisms, transport carriages, and the like and combinations thereof. Transport mechanisms for plastic cards are well known in the art. A person of ordinary skill in the art would readily understand the type(s) of card transport mechanisms that could be used, as well as the construction and operation of such card transport mechanisms.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of drop-on-demand printing on a plastic card having a first surface and a second surface in a card processing system that includes a drop-on-demand card printing mechanism that is configured to perform drop-on-demand printing, the method comprising:
in a first printing pass, applying at least one material to the first surface of the plastic card in the card processing system using at least one drop-on-demand print head of the drop-on-demand card printing mechanism;
in a second printing pass that occurs after the first printing pass, applying at least one additional material to the first surface of the plastic card in the card processing system using at least one drop-on-demand print head of the drop-on-demand card printing mechanism, the at least one additional material being applied at least partially over the at least one material.

2. The method of claim 1, wherein the at least one material is radiation curable; and
after the first printing pass, discharging electromagnetic radiation from an electromagnetic radiation source and directing at least a portion of the discharged electromagnetic radiation onto the at least one material applied to the first surface to at least partially cure the at least one material.

3. The method of claim 1, wherein the at least one additional material is radiation curable;
and
after the second printing pass, discharging electromagnetic radiation from an electromagnetic radiation source and directing at least a portion of the discharged electromagnetic radiation onto the at least one additional material applied to the first surface to at least partially cure the at least one additional material.

4. The method of claim 1, after the first printing pass, mechanically transporting the plastic card at least partially upstream of the drop-on-demand card printing mechanism, and thereafter performing the second printing pass.

5. The method of claim 2, in the first printing pass, applying two or more radiation curable materials to the first surface of the plastic card using two or more drop-on-demand print heads of the drop-on-demand card printing mechanism.

6. The method of claim 5, wherein the two or more radiation curable materials comprise two differently colored inks.

7. The method of claim 5, wherein the two or more radiation curable materials comprise a colored ink and a non-ink material.

8. The method of claim 3, wherein the at least one additional material comprises a colored ink or a non-ink material.

9. The method of claim 1, wherein the plastic card travels in a first direction during the first printing pass, and the plastic card travels in a second direction during the second printing pass, and the first direction is opposite the second direction.

10. The method of claim 1, between the first printing pass and the second printing pass, applying at least one material to a first surface or a second surface of at least one additional plastic card using at least one drop-on-demand print head of the drop-on-demand card printing mechanism.

11. A card processing system that implements the method of claim 1.

12. A card processing system, comprising:
a drop-on-demand card printing mechanism disposed along a card processing path, the drop-on-demand card printing mechanism includes:
a plurality of drop-on-demand print heads each of which prints a different radiation curable material; and
a first electromagnetic radiation source for curing radiation curable material applied to plastic cards by the drop-on-demand print heads and a second electromagnetic radiation source for curing radiation curable material applied to plastic cards by the drop-on-demand print heads, the first electromagnetic radiation source is downstream from the drop-on-demand print heads;
a mechanical card transport that transports a plastic card from a location downstream from the drop-on-demand print heads to a location upstream of the drop-on-demand print heads.

13. The card processing system of claim 12, wherein the second electromagnetic radiation source is between two of the drop-on-demand print heads.

14. The card processing system of claim 12, wherein one of the first electromagnetic radiation source and the second electromagnetic radiation source is configured to fully cure the radiation curable material, and the other one of the first electromagnetic radiation source and the second electromagnetic radiation source is configured to partially cure the radiation curable material.
